(19) United States
(12) Patent Application Publication
(10) Pub. No.: US 2024/0266577 A1
(43) Pub. Date: Aug. 8, 2024

(54) FUEL CELL

(71) Applicant: L'Air Liquide, Societe Anonyme pour l'Etude et l’Exploitation des Procedes Georges Claude, Paris (FR)

(72) Inventors: Johan ANDRE, Sassenage (FR); Denis SIRAC, Sassenage (FR)

(73) Assignee: L'Air Liquide, Societe Anonyme pour l'Etude et l’Exploitation des Procedes Georges Claude, Paris (FR)

(21) Appl. No.: 18/689,832

(22) PCT Filed: Apr. 26, 2022
(86) PCT No.: PCT/EP2022/073751

§ 371 Date: Mar. 6, 2024

(30) Foreign Application Priority Data
Sep. 6, 2021 (FR) FR 2109327

(51) Int. Cl. H01M 8/248; H01M 8/0276; H01M 8/2485

(52) U.S. Cl. CPC H01M 8/248; H01M 8/0276; H01M 8/2485

(57) ABSTRACT

The invention relates to a fuel cell having a stack of a plurality of cells, the stack being sandwiched between a first clamping plate and a second clamping plate, the fuel cell having a first flat seal and a distribution plate, the distribution plate comprising a first collection face, the first collection face and/or the first clamping plate having an annular lip arranged so as to clamp the first flat seal.

### CROSS REFERENCE TO RELATED APPLICATIONS

This application is a § 371 of International PCT Application PCT/EP2022/073751, filed Aug. 26, 2022, which claims the benefit of FR2109327, filed Sep. 6, 2021, both of which are herein incorporated by reference in their entireties.

### FIELD OF THE INVENTION

The present invention relates to a fuel cell, notably a proton-exchange membrane fuel cell (PEMFC), comprising a stack of elementary cells, the cells each comprising an anode plate and a cathode plate sandwiching a membrane electrode assembly (MEA).

### BACKGROUND OF THE INVENTION

The stack of such a fuel cell is sandwiched between two clamping plates to apply a given clamping pressure to the stack, at least one end of the stack comprising an electrically conductive current collector plate electrically connected to the cells of the stack to collect the sum of the electric currents produced by the cells.

Such a compression of the cell stack is often detrimental not just to fuel-cell performance, but also to fuel-cell service life. This is because an inadequately compressed zone exhibits increased electrical contact resistance compared to a more compressed zone. An inadequately compressed zone therefore has degraded operation resulting from greater ohmic losses. Conversely, a cell zone that is relatively over-compressed suffers from accelerated mechanical degradation.

Furthermore, at least one of the ends of the stack has pipework for the circulation of the reactant fluids (air or hydrogen) and for the circulation of the coolant fluid (often a liquid).

It is therefore important to correctly seal at least the interface at the end of the stack having the pipework for the circulation of the fluids, notably between the clamping plate and the electric current collector plate.

Known solutions often use a plurality of O-rings arranged on both sides of the electric current collector plate. This type of solution is complex to implement and there remains a high risk of leaks related to the compression of the stack in the passage zones of the different fluids.

### SUMMARY OF THE INVENTION

In certain embodiments, the present invention is intended to efficiently overcome these drawbacks by proposing a fuel cell having a stack of a plurality of cells, the stack being sandwiched between a first clamping plate and a second clamping plate to apply a predetermined clamping pressure to the stack, the plurality of cells having a first cell at a first end of the stack and a last cell at a second end of the stack, each cell of the plurality having an anode plate and a cathode plate, one of the plates of the first cell forming, with one of the plates of another of the cells, a first inter-cell cooling circuit, the other of the plates of the first cell defining a first end plate, one of the plates of the last cell forming, with one of the plates of another of the cells, a last inter-cell cooling circuit, the other of the plates of the last cell defining a last end plate, the fuel cell having a distribution plate comprising a first electric current collection face intended to face a first electric current collection plate and a distribution face intended to face the cooling face of the first end plate, the fuel cell having a first flat seal interposed between the distribution plate and the first clamping plate, the distribution plate having at least one fluid distribution manifold formed through the plate, the first electric current collection face and/or the first clamping plate having an annular lip formed about the distribution manifold so as to clamp the first flat seal to provide a fluidtight seal.

Such a configuration provides an appropriate fluid tight seal, the flat seal being clamped locally on the distribution manifold.

According to one embodiment, the fuel cell is a proton-exchange membrane fuel cell.

According to one embodiment, the anode plate and the cathode plate of each cell sandwich a membrane electrode assembly.

According to one embodiment, the distribution plate is fastened to the first end plate, notably by welding.

In a variant, the distribution plate and the first end plate form a single piece manufactured by molding and/or machining and/or hydroforming and/or pressing and/or three-dimensional printing.

Such fastening improves the fluidtight seal.

According to one embodiment, the distribution manifold is arranged such that all of the fluid entering the distribution manifold passes through the thickness of the distribution plate to distribute the fluid in the first cell.

According to one embodiment, the distribution plate has six distribution manifolds, notably to distribute or collect a fuel, an oxidant and a cooling fluid.

According to one embodiment, the annular lip is formed about the entire perimeter of the distribution manifold.

According to one embodiment, the annular lip projects from the plane of the plate.

According to one embodiment, the annular lip is integral with the first clamping plate.

In a variant, the annular lip is integral with the distribution plate.

According to one embodiment, one of either the first electric current collection face or the first clamping plate has an annular lip formed about the distribution manifold and the other of either the first electric current collection face or the first clamping plate has an annular groove, so as to clamp the first flat seal to provide a fluidtight seal.

According to one embodiment, the annular groove and the annular lip are arranged such that the lip faces the groove in the absence of the flat seal.

This arrangement enables the flat seal to be clamped, forming two folds in said flat seal.

According to one embodiment, the first flat seal, when unstressed, has a substantially constant thickness over the entire surface thereof.

According to one embodiment, the first flat seal has no boss.

According to one embodiment, the first flat seal has a flat face, the surface of which is at least equal to 80% of the surface of the face of the first end plate facing the first flat seal.

According to one embodiment, the first flat seal has a flat face, the surface of which is at least equal to 80% of the surface of the face of the first clamping plate.

According to one embodiment, the first flat seal is electrically insulating.

According to one embodiment, the first flat seal is made of a silicone-, elastomer-, or ethylene-propylene-diene-monomer-(EPDM) based material.

According to one embodiment, the first flat seal is in contact with at least a portion of the first collection plate and is in contact with at least a portion of the distribution plate.

According to one embodiment, the fuel cell does not have an O-ring arranged on either side of the first flat seal to provide a fluidtight seal.

According to one embodiment, the first electric current collection face has a first boss for receiving the first collection plate, such that the distribution plate and the first collection plate together form a flat face to come into contact with the first flat seal.

According to one embodiment, the first flat seal has at least one orifice to enable the fluid to pass between the first clamping plate and the distribution plate.

According to one embodiment, the first collection plate has a tongue projecting from the plane of the first collection plate and the first flat seal has a slot enabling the tongue to pass through the first flat seal.

According to one embodiment, the slot is distinct from the orifice.

According to one embodiment, the fuel cell has at least one tie rod for applying the clamping pressure to the stack.

According to one embodiment, the first flat seal has at least one through-hole for passage of the tie rod.

According to one embodiment, the first collection plate is electrically connected to the distribution plate.

According to one embodiment, each anode plate or cathode plate comprises a reactive face and a cooling face opposite one another, the reactive face of each plate being intended to face the membrane electrode assembly and being provided with relief elements and hollows forming a reactant circuit for the circulation of a reactant fluid, the cooling face of the cathode plate of at least one of the cells being intended to face the cooling face of the anode plate of another of the cells, defining between them relief elements and hollows to form an inter-cell cooling circuit for the circulation of a cooling fluid.

According to one embodiment, each cathode plate or anode plate has a reactant inlet manifold formed through the plate and in fluidic communication with the reactant circuit, a reactant outlet manifold formed through the plate and in fluidic communication with the reactant circuit, a cooling fluid inlet manifold formed through the plate, and a cooling fluid outlet manifold formed through the plate.

According to one embodiment, the fuel cell has a closure plate comprising a second electric current collection face intended to face a second electric current collection plate and a closure face fastened to the cooling face of the last end plate, the closure face and the cooling face of the last end plate defining between them relief elements and hollows to form a last cooling circuit for the circulation of the cooling fluid.

According to one embodiment, the fuel cell has a second flat seal interposed between the second collection plate and the second clamping plate.

According to one embodiment, the second flat seal, when unstressed, has a constant thickness over the entire surface thereof.

According to one embodiment, the second flat seal is electrically insulating.

According to one embodiment, the second flat seal has a flat face, the surface of which is at least equal to 80% of the surface of one of the faces of the second clamping plate.

According to one embodiment, the second flat seal has a flat face, the surface of which is at least equal to 80% of the surface of one of the faces of the closure plate.

According to one embodiment, the second electric current collection face has a second boss for receiving the second collection plate, such that the closure plate and the second collection plate form a flat face to come into contact with the second flat seal.

### BRIEF DESCRIPTION OF THE DRAWINGS

The invention will be understood better from reading the following description and from studying the figures. These figures are given only to illustrate, and in no way to limit, the invention.

FIG. 1 is a schematic representation, in section, of a fuel cell according to the invention, and

FIG. 2 is a schematic representation, in elevation, of the fuel cell in FIG. 1.

### DETAILED DESCRIPTION OF THE INVENTION

Those elements which are identical, similar or analogous keep the same reference from one figure to the next.

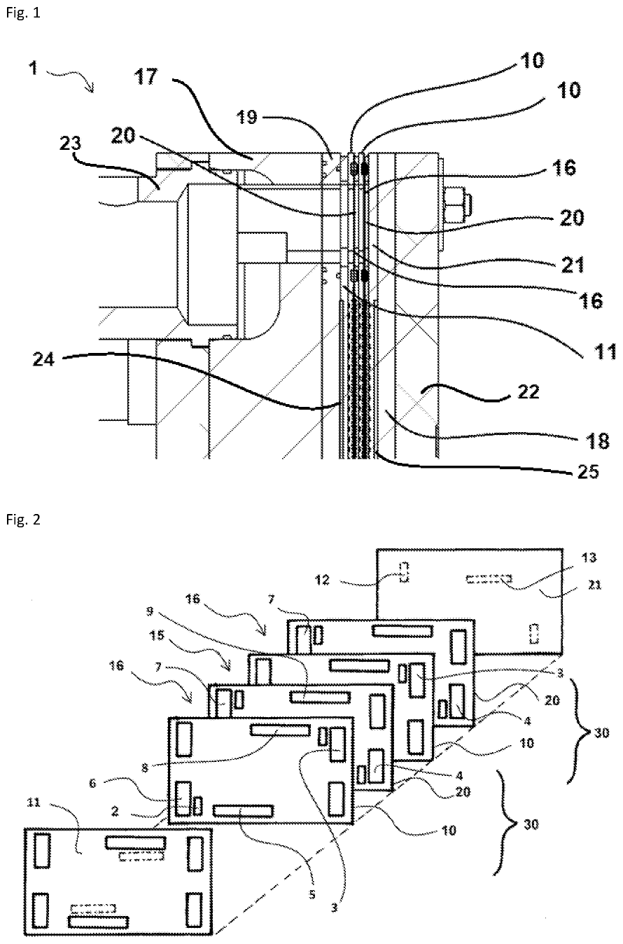

As shown in FIG. 1, a proton-exchange membrane fuel cell 1 has a stack of a plurality of cells 30, the stack being sandwiched between a first clamping plate 17, 23 and a second clamping plate 22 to apply a predetermined clamping pressure to the stack.

The plurality of cells 30 has a first cell 30 at a first end of the stack and a last cell 30 at a second end of the stack.

Each cell 30 of the plurality has an anode plate 10 and a cathode plate 20 sandwiching a membrane electrode assembly 16, one of the plates 10, 20 of the first cell 30 forming, with one of the plates 10, 20 of another of the cells 30, a first inter-cell cooling circuit 15, the other of the plates 10, 20 of the first cell 30 defining a first end plate, one of the plates 10, 20 of the last cell 30 forming, with one of the plates 10, 20 of another of the cells 30, a last inter-cell cooling circuit 15, the other of the plates 10, 20 of the last cell 30 defining a last end plate.

The fuel cell 1 has a distribution plate 11 comprising a first electric current collection face intended to face a first electric current collection plate 24 and a distribution face intended to face the cooling face of the first end plate.

The fuel cell 1 has a first flat seal 19 interposed between the distribution plate 11 and the first clamping plate 17, 23, the distribution plate 11 having at least one fluid distribution manifold formed through the plate, the first electric current collection face and/or the first clamping plate 17, 23 having an annular lip formed about the distribution manifold so as to clamp the first flat seal 19 to provide a fluidtight seal.

The first electric current collection face has a first boss for receiving the first collection plate 24, such that the distribution plate 11 and the first collection plate 24 together form a flat face to come into contact with the first flat seal 19.

The first flat seal 19 has at least one orifice to enable the fluid to pass between the first clamping plate 17, 23 and the distribution plate 11.

The first collection plate 24 has a tongue projecting from the plane of the first collection plate 24.

The first flat seal 19 has a slot to enable the tongue to pass through the first flat seal 19.

The fuel cell has at least one tie rod for applying the clamping pressure to the stack.

The first flat seal 19 has at least one through-hole for passage of the tie rod.

As shown in FIG. 1, the fuel cell 1 has a closure plate 21 comprising a second electric current collection face intended to face a second electric current collection plate 25 and a closure face fastened to the cooling face of the last end plate, the closure face and the cooling face of the last end plate defining between them relief elements and hollows to form a last cooling circuit for the circulation of the cooling fluid.

The fuel cell 1 has a second flat seal 18 interposed between the second collection plate 25 and the second clamping plate 22.

FIG. 2 shows the fuel cell 1 in elevation, before assembly.

As shown in FIG. 2, each plate 10, 20 has:
a reactant inlet manifold 3, 4 formed through the plate 10, 20 and in fluidic communication with the reactant circuit via a first aperture 2 formed through the plate 10, 20,
a reactant outlet manifold 6, 7 formed through the plate 10, 20 and in fluidic communication with the reactant circuit via a second aperture 2 formed through the plate 10, 20,
a cooling fluid inlet manifold 5 formed through the plate 10, 20,
a cooling fluid outlet manifold 8, 9 formed through the plate 10, 20,
at least two orifices formed through the plate 10, 20, each orifice being arranged to allow fluidic communication through the plate 10, 20 only, without being in fluidic communication with the reactant circuit.

The reactant inlet manifold 3 of an anode plate 10 is in fluidic communication with one of the orifices of a cathode plate 20 and the reactant outlet manifold 6 of the anode plate 10 is in fluidic communication with another of the orifices of the cathode plate 20.

The reactant inlet manifold 3 of a cathode plate 20 is in fluidic communication with one of the orifices of an anode plate 10 and the reactant outlet manifold 6 of the cathode plate 20 is in fluidic communication with another of the orifices of the anode plate 10.

Thus, the stack allows a dedicated distribution of the reactant fluid for the anode plates 10 and a dedicated distribution of the reactant fluid for the cathode plates 20, forming two independent circuits.

The closure face of the closure plate 21 has a reactant passage 12, 13 formed by relief elements and hollows, to allow fluidic communication between the reactant inlet manifold 3, 4 and the reactant circuit or to allow fluidic communication between the reactant outlet manifold 6, 7 and the reactant circuit.

The closure face of the closure plate 21 has a cooling passage 13 formed by relief elements and hollows, to allow fluidic communication between the cooling fluid inlet manifold 5 and the cooling circuit, or to allow fluidic communication between the cooling fluid outlet manifold 8, 9 and the cooling circuit.

The reactant passage 12, 13 and the cooling passage 13 may be arranged on the closure face, on the last end plate, or on both of these.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-10. (canceled)

11. A fuel cell having:
a stack of a plurality of cells, the stack being sandwiched between a first clamping plate and a second clamping plate configured to apply a predetermined clamping pressure to the stack,
wherein the plurality of cells has a first cell at a first end of the stack and a last cell at a second end of the stack,
wherein each cell of the plurality of cells has an anode plate and a cathode plate,
wherein one of the anode or cathode plates of the first cell forms, with one of the anode or cathode plates of another of the cells, a first inter-cell cooling circuit,
wherein a remaining plate of the first cell defines a first end plate, wherein a remaining plate of the last cell forms, with one of the anode or cathode plates of another of the cells, a last inter-cell cooling circuit, wherein a remaining plate of the last cell defines a last end plate;
a distribution plate comprising:
a first electric current collection face configured to face a first electric current collection plate and
a distribution face configured to face the cooling face of the first end plate; and
a first flat seal interposed between the distribution plate and the first clamping plate,
wherein the distribution plate has at least one fluid distribution manifold formed through the plate,
wherein the first electric current collection face and/or the first clamping plate has an annular lip formed about the distribution manifold so as to clamp the first flat seal to provide a fluid tight seal.

12. The fuel cell as claimed in claim 11 wherein, the first flat seal has, when unstressed, a substantially constant thickness over the entire surface thereof.

13. The fuel cell as claimed in claim 11, wherein the first flat seal has a flat face, the surface of which is at least equal to 80% of the surface of the face of the first end plate facing the first flat seal.

14. The fuel cell as claimed in claim 11 wherein the first flat seal is electrically insulating.

15. The fuel cell as claimed in claim 11 wherein the first flat seal is in contact with at least a portion of the first collection plate and being in contact with at least a portion of the distribution plate.

16. The fuel cell as claimed in claim 11 wherein the fuel cell comprises an absence of an O-ring arranged on either side of the first flat seal to provide a fluid tight seal.

17. The fuel cell as claimed in claim 11 wherein the first electric current collection face has a first boss for receiving the first collection plate, such that the distribution plate and the first collection plate together form a flat face to come into contact with the first flat seal.

18. The fuel cell as claimed in claim 11 wherein the first flat seal has at least one orifice to enable the fluid to pass between the first clamping plate and the distribution plate.

19. The fuel cell as claimed in claim 11 wherein the first collection plate has a tongue projecting from the plane of the first collection plate and the first flat seal having a slot enabling the tongue to pass through the first flat seal.

20. The fuel cell as claimed in claim 11 wherein the fuel cell has at least one tie rod configured to apply the clamping pressure to the stack, the first flat seal having at least one through-hole for passage of the tie rod.
